(19) United States
(12) Patent Application Publication
(10) Pub. No.: US 2026/0253796 A1
(43) Pub. Date: Aug. 27, 2026

(54) MULTILAYER CERAMIC CAPACITOR

(71) Applicant: Murata Manufacturing Co., Ltd., Nagaokakyo-shi (JP)

(72) Inventor: Ryuya KOBAYASHI, Nagaokakyo-shi (JP)

(21) Appl. No.: 19/652,271

(22) Filed: Apr. 20, 2026

Related U.S. Application Data
(63) Continuation of application No. PCT/JP2024/039383, filed on Nov. 6, 2024.

(30) Foreign Application Priority Data
Jan. 25, 2024 (JP) 2024-009220

(51) Int. Cl. H01G 4/008; H01G 2/06; H01G 4/012; H01G 4/12; H01G 4/232; H01G 4/30

(52) U.S. Cl. CPC H01G 4/008; H01G 2/065; H01G 4/012; H01G 4/1209; H01G 4/2325; H01G 4/30

(57) ABSTRACT

A multilayer ceramic capacitor includes a multilayer body including dielectric layers and inner electrodes stacked alternately, a first principal surface and a second principal surface facing each other in a stacking direction, two side surfaces facing each other in a width direction perpendicular to the stacking direction, and two end surfaces facing each other in a length direction perpendicular to the stacking direction and the width direction, and two outer electrodes on the respective end surfaces. In the multilayer body, in a section along the length direction and the stacking direction in a center portion in the width direction, a dimension in the stacking direction between the first principal surface and the second principal surface in a center portion in the length direction is smaller than a dimension in the stacking direction between the first principal surface and the second principal surface in both end portions in the length direction.

### CROSS REFERENCE TO RELATED APPLICATIONS

This application claims the benefit of priority to Japanese Patent Application No. 2024-009220 filed on Jan. 25, 2024 and is a Continuation Application of PCT Application No. PCT/JP2024/039383 filed on Nov. 6, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor includes a multilayer body including alternately stacked dielectric layers and inner electrodes, and an outer electrode electrically connected to the inner electrodes. The multilayer ceramic capacitor is mounted on a substrate for use. The multilayer ceramic capacitor is mounted on the substrate by soldering. Solder paste includes a flux component that may cause a malfunction of the multilayer ceramic capacitor. In order to reduce the possibility of such a malfunction, flux is removed from the multilayer ceramic capacitor having been mounted on the substrate with use of flux cleansing liquid (see Japanese Unexamined Patent Application Publication No. 2020-202335).

### SUMMARY OF THE INVENTION

However, the flux cleansing liquid is less likely to enter a narrow space between a substrate and a multilayer body in a conventional multilayer ceramic capacitor. This may lead to insufficient removal of flux with use of the flux cleansing liquid.

Example embodiments of the present invention provide multilayer ceramic capacitors that each facilitate flux removal with use of flux cleansing liquid.

A multilayer ceramic capacitor according to an example embodiment of the present invention includes a multilayer body including a plurality of dielectric layers and a plurality of inner electrodes stacked alternately, a first principal surface and a second principal surface facing each other in a stacking direction, a first side surface and a second side surface facing each other in a width direction perpendicular to the stacking direction, and a first end surface and a second end surface facing each other in a length direction perpendicular to the stacking direction and the width direction, the plurality of inner electrodes including a first inner electrode extended to the first end surface and a second inner electrode extended to the second end surface, a first outer electrode on the first end surface and a second outer electrode on the second end surface. In the multilayer body, in a section along the length direction and the stacking direction in a center portion in the width direction, a dimension in the stacking direction between the first principal surface and the second principal surface in a center portion in the length direction is smaller than a dimension in the stacking direction between the first principal surface and the second principal surface in both end portions in the length direction.

Example embodiments of the present invention provide multilayer ceramic capacitors that each facilitate flux removal with use of flux cleansing liquid.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a WT sectional view taken along line II-II indicated in FIG. 1, in a center portion in a length direction L.

FIG. 3 is an LT sectional view taken along line III-III indicated in FIG. 1, in a center portion in a width direction W.

FIG. 4 is a table indicating investigation results on outer appearance defects and short circuit defects in multilayer ceramic capacitors according to an example embodiment and a comparative mode.

FIG. 5 is a view of a multilayer ceramic capacitor 1A according to a first variation of an example embodiment of the present invention.

FIG. 6 is a view of a multilayer ceramic capacitor 1B according to a second variation of an example embodiment of the present invention.

FIG. 7 is a view of a multilayer ceramic capacitor 1C according to a third variation of an example embodiment of the present invention.

FIG. 8 is a view of a multilayer ceramic capacitor 1D according to a fourth variation of an example embodiment of the present invention.

### DETAILED DESCRIPTION OF THE EXAMPLE EMBODIMENTS

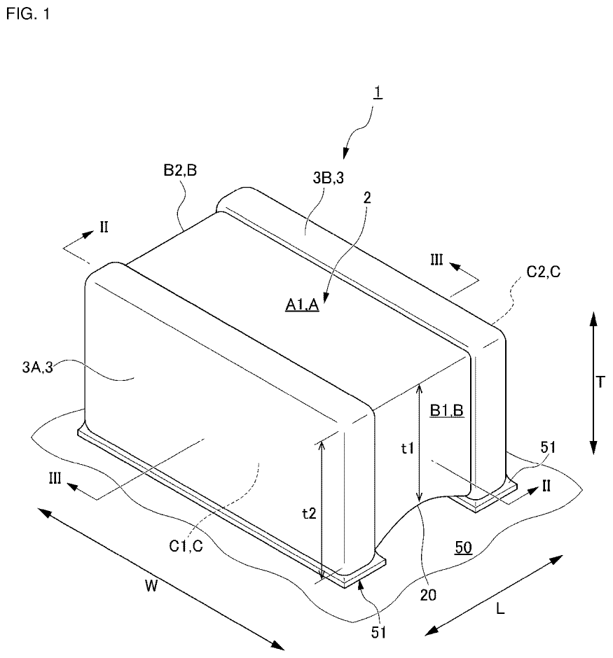

Multilayer ceramic capacitors according to example embodiments of the present invention will be described below. FIG. 1 is a schematic perspective view of a multilayer ceramic capacitor 1 according to a present example embodiment.

The multilayer ceramic capacitor 1 is substantially a rectangular parallelepiped, and includes a multilayer body 2, and a pair of outer electrodes 3 provided at both ends of the multilayer body 2. The multilayer body 2 includes an inner layer portion 11 including a plurality of dielectric layers 14 and a plurality of inner electrodes 15 stacked therein, and an outer layer portion 12.

In the following description, as expressions indicating directions of the multilayer ceramic capacitor 1, a direction in which the pair of outer electrodes 3 are provided in the multilayer ceramic capacitor 1 will be referred to as a length direction L, a direction in which the dielectric layers 14 and the inner electrodes 15 are stacked will be referred to as a stacking direction T, and a direction that crosses both the length direction L and the stacking direction T will be referred to as a width direction W. In the present example embodiment, the width direction W is perpendicular to both the length direction L and the stacking direction T.

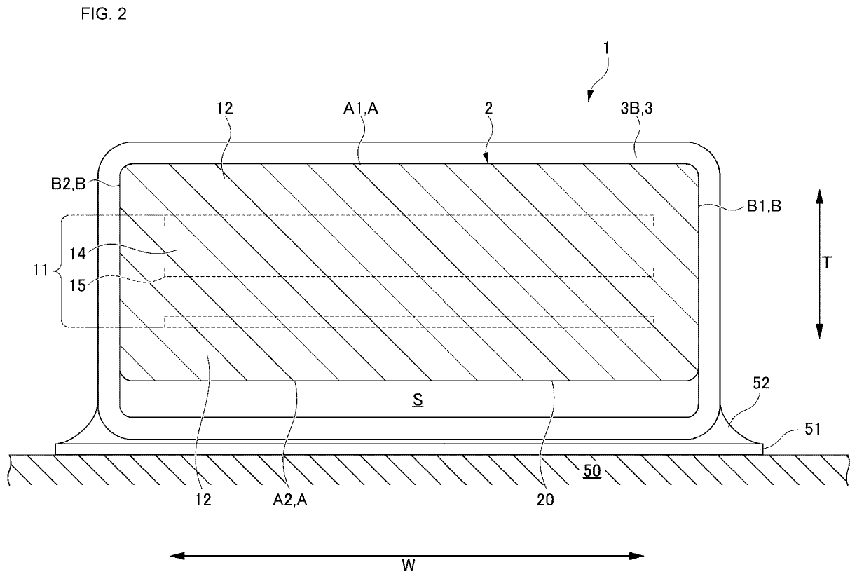

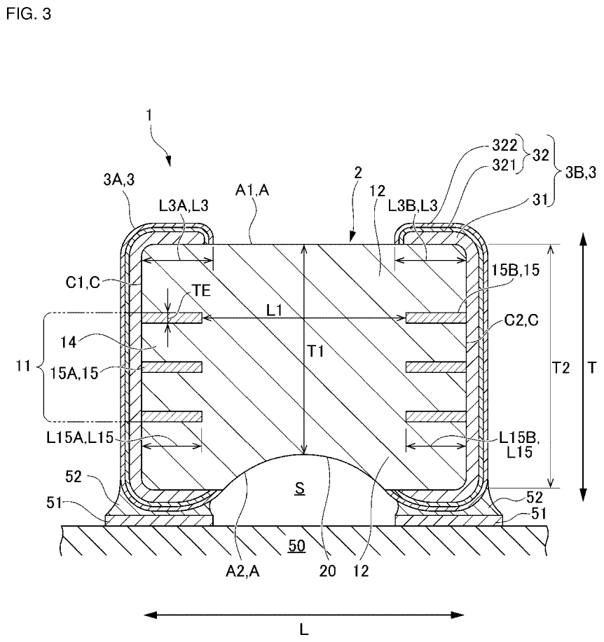

FIG. 2 is a sectional view along the width direction W and the stacking direction T, taken along line II-II indicated in FIG. 1, in a center portion in the length direction L. Such a section will hereinafter be referred to as a WT section. FIG. 3 is a sectional view along the length direction L and the stacking direction, taken along line III-III indicated in FIG. 1, in a center portion in the width direction W. Such a section will hereinafter be referred to as an LT section.

In the following description, of six outer peripheral surfaces of the multilayer body 2 shown in FIG. 2, a pair of outer peripheral surfaces facing each other in the stacking direction T will be referred to as a first principal surface A1 and a second principal surface A2, and will be collectively referred to as principal surfaces A if the first principal surface A1 and the second principal surface A2 do not particularly need to be distinguished from each other. A pair of outer peripheral surfaces facing each other in the width direction W will be referred to as a first side surface B1 and a second side surface B2, and will be collectively referred to as side surfaces B if the first side surface B1 and the second side surface B2 do not particularly need to be distinguished from each other. A pair of outer peripheral surfaces facing each other in the length direction L will be referred to as a first end surface C1 and a second end surface C2, and will be collectively referred to as end surfaces C if the first end surface C1 and the second end surface C2 do not particularly need to be distinguished from each other.

The multilayer ceramic capacitor 1 according to the present example embodiment has a dimension in the length direction L smaller than a dimension in the width direction W. The multilayer ceramic capacitor 1 according to the present example embodiment has, for example, a dimension in the length direction L of about 0.2 mm or more and about 0.6 mm or less, a dimension in the width direction W of about 0.4 mm or more and about 1 mm or less, and a dimension in the stacking direction T of about 0.1 mm or more and about 0.9 mm or less, for example, although the multilayer ceramic capacitor 1 is not limited thereto.

The multilayer body 2 preferably includes rounded corner portions and ridge portions. A corner portion corresponds to a portion where three surfaces of the multilayer body 2 cross one another, whereas a ridgeline portion corresponds to a portion where two surfaces of the multilayer body 2 cross each other. Furthermore, the principal surfaces A, the side surfaces B, and the end surfaces C may be partially or entirely provided with fine protrusions and recesses that are different from a recessed portion 20 to be described below.

As shown in FIG. 3, the multilayer body 2 according to the present example embodiment is substantially a rectangular parallelepiped. In the LT section, a dimension T1 in the stacking direction T between the first principal surface A1 and the second principal surface A2 in the center portion in the length direction L is smaller than a dimension T2 in the stacking direction T between the first principal surface A1 and the second principal surface A2 in both end portions in the length direction L.

In other words, in the LT section of the multilayer body 2 according to the present example embodiment, the dimension T1 in the stacking direction T between the first principal surface A1 and the second principal surface A2 in the center portion in the length direction L is smaller than both the dimension T2 in the stacking direction T between the first principal surface A1 and the second principal surface A2 on the first end surface C1 and the dimension T2 in the stacking direction T between the first principal surface A1 and the second principal surface A2 on the second end surface C2.

The center portion in the length direction L of the multilayer body 2 corresponds to a center portion between the first end surface C1 and the second end surface C2 of the multilayer body 2. That is, the center portion indicates a position shifted in the length direction L from one of the end surfaces C by about ½ of a distance between the first end surface C1 and the second end surface C2.

The center portion in the width direction W of the multilayer body 2 basically similarly corresponds to a center portion between the first side surface B1 and the second side surface B2 of the multilayer body 2. That is, the center portion indicates a position shifted in the width direction W from one of the side surfaces B by about ½ of a distance between the first side surface B1 and the second side surface B2. The center portion is, however, not limited to the position at about ½ of the dimension in the width direction W, and may alternatively indicate any position from a position at about ⅓ of the dimension in the width direction W to a position at about ⅔ of the dimension in the width direction W, for example.

The first principal surface A1 of the multilayer body 2 is flat in the present example embodiment. The second principal surface A2 of the multilayer body 2 is thus provided in a center portion with the recessed portion 20 recessed in the stacking direction T so as to establish T1<T2. However, the second principal surface A2 of the multilayer body 2 has a linear contour in the width direction W in the WT section shown in FIG. 2.

The recessed portion 20 in the second principal surface A2 is formed such that a dimension from the first principal surface A1 to the second principal surface A2 gradually increases at least partially from the center portion in the length direction L to both end portions in the length direction L in the LT section shown in FIG. 3. According to the present example embodiment, the dimension from the first principal surface A1 to the second principal surface A2 gradually increases in the entire length from the center portion in the length direction L to positions of end portions of the outer electrodes 3 adjacent to the principal surfaces.

Furthermore, T2/T1 is preferably about 1.01 or more, and is more preferably about 1.033 or more and about 1.201 or less, for example.

Moreover, T2−T1 is preferably larger than a total ΣTE of dimensions (thicknesses of the inner electrodes 15) TE in the stacking direction T of first inner electrodes 15A or second inner electrodes 15B ((T2−T1)>ΣTE).

As shown in FIG. 1, in the first side surface B1 and the second side surface B2 of the multilayer body 2, a dimension t1 in the stacking direction T between the first principal surface A1 and the second principal surface A2 in the center portion in the length direction L is smaller than a dimension t2 in the stacking direction T between the first principal surface A1 and the second principal surface A2 in both end portions in the length direction L. Furthermore, t2/t1 is also preferably about 1.01 or more, and is more preferably about 1.033 or more and about 1.201 or less, for example.

T1 and T2 can be measured in the following manner.
(1) The multilayer ceramic capacitor 1 is ground along the LT section to expose the LT section at about ½ of the dimension in the width direction W. The LT section thus exposed is observed by microscopy.
(2) In this LT section, the smallest dimension in the stacking direction T between the first principal surface A1 and the second principal surface A2 is measured as T1.
(3) Measured in this LT section is the dimension in the stacking direction T between the first principal surface A1 and the second principal surface A2 on each of the first end surface C1 and the second end surface C2. Obtained as T2 is an average value between the dimension in the stacking direction T between the first principal surface A1 and the second principal surface A2 on the first end surface C1 and the dimension in the stacking direction T between the first principal surface A1 and the second principal surface A2 on the second end surface C2.

Measurement of t2 and t1 can be achieved similarly to measurement of T1and T2 by exposing a side surface through grinding and then executing a procedure similar to that for T1and T2.

The dielectric layers 14 include, as a principal component, a ceramic material including at least one of Ca, Sr, Zr, or Ti. Specifically, for example, the principal component is a ceramic material including Ca and Zr and having a perovskite structure expressed by a general formula ABO₃. Non-limiting examples of the ceramic material having the perovskite structure include CaZrO₃ (calcium zirconate) and TiO₂ (titanium oxide). The principal component of the ceramic material for the dielectric layers 14 may include all of Ca, Zr, and Ti. Also applicable is Ca(Zr0.9Ti0.1)O₃ or the like obtained by substituting Ti for part of ZrO₃ or Zr in CaZrO₃.

Examples of the ceramic material for the dielectric layers 14 may include (Ca1-x-y, Srx, Bay)m(Zr1-z-α, Tiz, Hfα)O₃ (wherein x is 0 or more and 1 or less, y is 0 or more and 0.4 or less, m is 1.0 or more and 1.1 or less, z is 0 or more and 0.2 or less, and α is 0 or more and 0.3 or less).

An additive is added to the ceramic material for the dielectric layers 14 depending on the purpose. Examples of such an additive include Mn, Mg, Dy, Cr, an oxide of a rare earth element such as V, Sm, Eu, Gd, Tb, Ho, Er, Tm, Yb, or Y, an oxide of Co, Ni, Li, B, Na, K, or Si, and glass.

The thickness of each of the dielectric layers 14 can be obtained by measuring a distance between two adjacent first inner electrodes 15A or a distance between two adjacent second inner electrodes 15B, and is, for example, about 1 μm or more and about 100 μm or less.

The plurality of inner electrodes 15 includes the first inner electrodes 15A extended to the first end surface C1, and the second inner electrodes 15B extended to the second end surface C2. The number of the first inner electrodes 15A and the number of the second inner electrodes 15B are, for example, 1 or more and 50 or less, but are not limited thereto.

As shown in FIG. 3, the first inner electrodes 15A and the second inner electrodes 15B according to the present example embodiment do not overlap each other in the stacking direction T. A total dimension in the length direction L of each of the first inner electrodes 15A and each of the second inner electrodes 15B is smaller than a dimension in the length direction L of the multilayer body 2.

The first inner electrode 15A and the second inner electrode 15B are positioned in an identical plane. That is, the first inner electrode 15A and the second inner electrode 15B each have a dimension in the length direction L smaller than half of the dimension in the length direction L of the multilayer body 2, and are disposed in a parallel manner in a substantially identical plane (in an LW section) along the length direction L and the width direction W. The multilayer ceramic capacitor 1 according to the present example embodiment thus has a so-called opposing structure in which the first inner electrode 15A and the second inner electrode 15B are separated from each other in the length direction L.

Furthermore, the inner electrodes 15 have a dimension L15 in the length direction L, which may be smaller than an average dimension L3 in the length direction L of the outer electrodes 3 (folded portions) disposed on the principal surfaces A. Specifically, in the LT section, a dimension L15A in the length direction L of the first inner electrode 15A may be made smaller than an average dimension L3A in the length direction L of a first outer electrode 3A disposed on the first principal surface A1 and the second principal surface A2. A dimension L15B in the length direction L of the second inner electrode 15B may be made smaller than an average dimension L3B in the length direction L of a second outer electrode 3B disposed on the first principal surface A1 and the second principal surface A2.

The dimensions in the length direction L of the inner electrodes 15 are smaller than the average dimension in the length direction L of the outer electrodes 3 disposed on the principal surfaces A, so as to reduce or minimize the possibility of contact between the first inner electrodes 15A and the second outer electrode 3B and contact between the second inner electrodes 15B and the first outer electrode 3A. This achieves a reduction in the possibility of a short circuit defect.

In the LT section shown in FIG. 3, a distance L1 between an end portion adjacent to the second end surface C2 of the first inner electrode 15A and an end portion adjacent to the first end surface C1 of the second inner electrode 15B is preferably, for example, about 5 μm or more and about 400 μm or less.

Each of the inner electrodes 15 is a conductive thin film including at least one of Ni, Cu, Ag, Pd, an alloy of Ag and Pd, or a metal such as Au. The inner electrodes 15 preferably include Cu for excellent frequency characteristics of the multilayer ceramic capacitor 1. The inner electrodes 15 may further include dielectric particles having an identical composition system to ceramic included in the dielectric layers 14.

More specifically, the inner electrodes 15 may include Cu and an underlying electrode of each of the outer electrodes 3 to be described later may include Cu, or the inner electrodes 15 may include Ni and the underlying electrode of each of the outer electrodes 3 to be described later may include Ni.

Each of the inner electrodes 15 preferably has a thickness of, for example, about 0.5 μm or more and about 10 μm or less.

The outer layer portion 12 is an aggregate of a plurality of dielectric layers 14 made of the same dielectric ceramic material as the dielectric layers 14 in the inner layer portion 11. The outer layer portion 12 is not limited to this configuration, and may be made of a dielectric ceramic material different from the material for the dielectric layers 14.

The outer electrodes 3 include the first outer electrode 3A and the second outer electrode 3B. The first outer electrode 3A covers the first end surface C1 of the multilayer body 2, and is disposed to be connected to the first inner electrodes 15A extended to the first end surface C1. The first outer electrode 3A is preferably provided to reach a portion of each of the first principal surface A1 and the second principal surface A2, and a portion of each of the first side surface B1 and the second side surface B2. The first outer electrode 3A may alternatively be disposed only on the first end surface C1.

The second outer electrode 3B covers the second end surface C2 of the multilayer body 2, and is disposed to be connected to the second inner electrodes 15B extended to the second end surface C2. The second outer electrode 3B is preferably provided to reach a portion of each of the first principal surface A1 and the second principal surface A2, and a portion of each of the first side surface B1 and the second side surface B2. The second outer electrode 3B may alternatively be disposed only on the second end surface C2.

Hereinafter, the first outer electrode 3A and the second outer electrode 3B will be described collectively as the outer electrodes 3 when the first outer electrode 3A and the second outer electrode 3B do not particularly need to be distinguished from each other. Each of the outer electrodes 3 includes an underlying electrode layer 31 and a plating layer 32.

The underlying electrode layer 31 includes at least one of a baked layer, a resin layer, or a thin film layer, or the like. The underlying electrode layer 31 covers the end surface C of the multilayer body 2, and is disposed to be connected to the inner electrodes 15 extended to the end surface C.

The baked layer includes a glass component and a metal. The glass component includes at least one of B, Si, Ba, Mg, Al, or Li, or the like. The metal in the baked layer includes, for example, at least one of Cu, Ni, Ag, Pd, an Ag-Pd alloy, or Au, or the like. The baked layer may include a plurality of layers. The baked layer is obtained by applying a conductive paste including glass and a metal to the multilayer body 2 and baking the conductive paste. The baked layer may be fired simultaneously with the inner electrodes 15 and the dielectric layers 14, or may be baked after the inner electrodes 15 are fired. When the baked layer is fired simultaneously with the inner electrodes 15 and the dielectric layers 14, a dielectric material is preferably added in place of the glass component to form the baked layer. The thickest portion of the baked layer preferably has a thickness of, for example, about 5 μm or more and about 50 μm or less.

The resin layer may include a plurality of layers. The resin layer includes, for example, conductive particles and a thermosetting resin. The resin layer may be formed directly on the multilayer body 2 without forming a baked electrode layer, and may be formed to cover the baked layer. The resin layer may be formed on a surface of the baked layer, or may be formed directly on a surface of the end surface C without forming a baked layer. The resin layer (the thickest portion) preferably has a thickness of, for example, about 5 μm or more and about 150 μm or less.

The thin film layer is formed in accordance with a thin film forming method such as a sputtering method or an evaporation method, is made of accumulated metal particles, and is about 1 μm or less in thickness, for example.

The plating layer 32 is disposed to cover the underlying electrode layer 31. The plating layer 32 includes, for example, at least one of Cu, Ni, Sn, Ag, Pd, an Ag-Pd alloy, or Au, or the like. The plating layer 32 may include a plurality of layers.

The plating layer 32 preferably has a two-layer structure including a Ni plating 321 and a Sn plating 322. The Ni plating layer 321 can prevent erosion of the underlying electrode layer 31 by solder used for mounting a ceramic electronic component, whereas the Sn plating layer 322 improves wettability of solder used for mounting the ceramic electronic component to facilitate mounting. The plating layer 32 preferably has a thickness of about 0.5 μm or more and about 10 μm or less per layer, for example.

As one example, the multilayer ceramic capacitor 1 according to the present example embodiment can be manufactured through the following steps.

A conductive material such as a conductive paste to provide the inner electrodes 15 is initially printed on each ceramic material such as a ceramic green sheet to provide the dielectric layer 14, to prepare the ceramic green sheet provided with an inner electrode pattern.

Ceramic green sheets each provided with the inner electrode pattern are stacked, and provided on each of the top and the bottom thereof is a ceramic green sheet provided with no inner electrode pattern to provide the outer layer portion 12, to form a mother block.

This mother block is subsequently pressed. The mother block is pressed from a surface to provide the second principal surface A2 toward the first principal surface A1 with use of rubber or the like. At this stage, pressure applied to a site around the center portion in the length direction L of the multilayer body 2 is made larger than pressure applied to the end portions in the length direction L to form the recessed portion 20 in the second principal surface A2.

The multilayer ceramic capacitor 1 according to the present example embodiment includes the inner electrodes 15 having the butting structure. Accordingly, the inner electrodes 15 and the dielectric layers 14 in the center portion in the length direction L are smaller in the numbers of stacked layers than the inner electrodes 15 and the dielectric layers 14 on the end surfaces C to which the first inner electrodes 15A and the second inner electrodes 15B are extended. Furthermore, the pressure applied to the site around the center portion in the length direction L of the multilayer body 2 is made larger than the pressure applied to the end portions in the length direction L in the pressing step.

Therefore, this pressing step facilitates setting the dimension in the stacking direction T of the center portion in the length direction L of the multilayer body 2 to be smaller than the dimensions in the stacking direction T on the end surfaces C and forming the recessed portion 20 in the center portion in the length direction L of the second principal surface A2.

The recessed portion 20 may be formed in a manner different from this manufacturing method, by reducing the thickness of the dielectric layer 14 as a portion to be provided with the recessed portion 20, or by hollowing a portion of the dielectric layer 14 to provide the outer layer portion provided with no printed inner electrodes 15.

The mother block thus pressed is cut into a predetermined dimension to obtain an unfired multilayer body 2.

The multilayer body 2 is subsequently fired.

The outer electrodes 3 are subsequently formed by baking, plating, or the like. The outer electrodes 3 except for plating may be formed by partially or entirely baking simultaneously with firing the multilayer body 2.

The multilayer ceramic capacitor 1 according to the present example embodiment is manufactured through the steps described above.

In the multilayer ceramic capacitor 1, one of the outer electrodes 3 (first outer electrode 3A) is connected to a first land 51 via solder 52, and the other one of the outer electrodes 3 (second outer electrode 3B) is connected to a second land 51 via solder 52. The multilayer ceramic capacitor 1 according to the present example embodiment is thus mounted on a substrate. A surface of the substrate 50 not provided with the lands 51 and excluding a predetermined mounting region is covered with an insulating film made of solder resist.

When the multilayer ceramic capacitor 1 is mounted onto the substrate 50 by soldering, flux is used to promote soldering. The multilayer ceramic capacitor 1 thus mounted on the substrate is rinsed to remove the flux.

However, flux may remain due to insufficient rinsing. With such a residual flux, application of voltage between electrodes of the multilayer ceramic capacitor 1 may cause migration, which is an electrochemical phenomenon in which an anode metal ionizes and migrates to a cathode and, upon receiving electrons at the cathode, precipitates and grows as metal. This may cause an outer appearance defect or a short circuit defect.

As shown in FIG. 3, in the LT section of the multilayer ceramic capacitor 1 according to the present example embodiment, the dimension T1 in the stacking direction T between the first principal surface A1 and the second principal surface A2 in the center portion in the length direction L is smaller than the dimension T2 in the stacking direction T between the first principal surface A1 and the second principal surface A2 in both end portions in the length direction L. The first principal surface A1 of the multilayer body 2 is flat, and the second principal surface A2 of the multilayer body 2 is thus provided in the center portion with the recessed portion 20 recessed in the stacking direction T so as to establish T1 <T2.

Accordingly, on the second principal surface A2 side of the multilayer body 2 as a substrate mounting side, a large space S is present between a portion not provided with the outer electrodes 3 and the substrate 50. This configuration allows flux cleansing liquid to easily enter the space between the multilayer ceramic capacitor 1 and the substrate to reduce residue due to insufficient rinsing. This can reduce the likelihood of a malfunction due to residual flux.

In this case, T2/T1 being about 1.01 or more, for example, achieves excellent detersiveness with use of cleansing liquid, and T2/T1 being about 1.033 or more and about 1.201 or less, for example, achieves more excellent detersiveness.

Furthermore, as shown in FIG. 1, in the first side surface B1 and the second side surface B2 of the multilayer body 2, the dimension t1 in the stacking direction T between the first principal surface A1 and the second principal surface A2 in the center portion in the length direction L is smaller than the dimension t2 in the stacking direction T between the first principal surface A1 and the second principal surface A2 in both end portions in the length direction L.

This configuration enlarges an inlet and an outlet for the flux cleansing liquid to and from the space S in each of the first side surface B1 and the second side surface B2. The flux cleansing liquid can thus externally flow into and can flow out of the space S to improve a detersive effect on the flux. This can further reduce the likelihood of a malfunction due to residual flux.

As described above, the multilayer ceramic capacitor 1 according to the present example embodiment allows the flux cleansing liquid to easily enter the space between the multilayer ceramic capacitor 1 and the substrate to reduce residue due to insufficient rinsing. This can reduce the likelihood of a malfunction due to residual flux.

In order to verify the effect mentioned above, the multilayer ceramic capacitor 1 according to the present example embodiment and a multilayer ceramic capacitor according to a comparative mode were prepared and examined for occurrence of an outer appearance defect and a short circuit defect due to a migration defect.

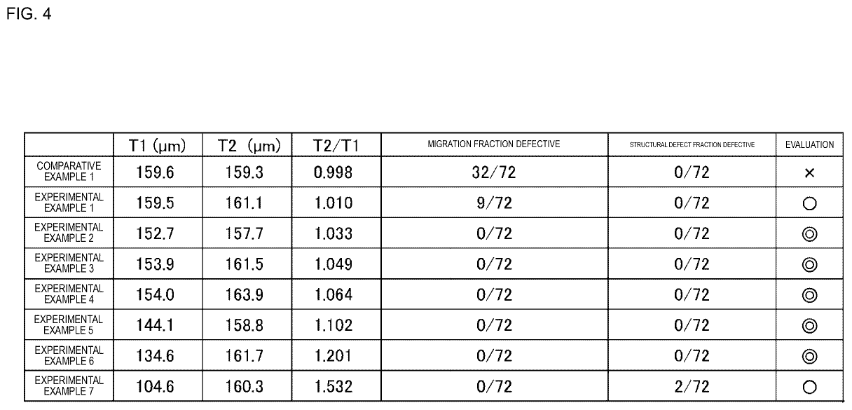

Manufactured in accordance with the manufacturing method described above were multilayer ceramic capacitors 1 according to Examples 1, 2, 3, 4, 5, 6, and 7 of the example embodiments in which the dimension T1 in the stacking direction T between the first principal surface A1 and the second principal surface A2 in the center portion in the length direction L was smaller than the dimension T2 in the stacking direction T between the first principal surface A1 and the second principal surface A2 in both end portions in the length direction L in the LT section in the center portion in the width direction W and T2/T1 was about 1.01 or more as shown in FIG. 3, and a multilayer ceramic capacitor according to Comparative Example 1 in which T1 was slightly larger than T2 and T2/T1 was about 0.998. FIG. 4 is a table indicating the dimensions T1 and T2, and T2/T1 of each of the multilayer ceramic capacitors.

The multilayer ceramic capacitor according to Comparative Example 1 was manufactured by stacking ceramic green sheets such that the inner electrodes 15 adjacent to each other in the stacking direction T overlapped each other in the center portion in the length direction L and evenly pressing the entire stacked sheets.

72 multilayer ceramic capacitors according to Comparative Example 1 and 72 multilayer ceramic capacitors 1 according to each of Examples 1, 2, 3, 4, 5, 6, and 7 were selected at random and were inspected for the presence or absence of a structural defect of outer appearance by optical microscopy. Multilayer ceramic capacitors having a structural defect were counted, and the structural defect fraction defective was calculated with the total number of the multilayer ceramic capacitors 1 used for the verification as a denominator. FIG. 4 indicates results thereof in “structural defect fraction defective”.

Example 7 in which T2/T1 was 1.53 had a structural defect fraction defective of 2/72, whereas Comparative Example 1 and Examples 1, 2, 3, 4, 5, and 6 each had a structural defect fraction defective of 0/72. Example 7 was higher in structural defect fraction defective than the other examples probably because the dielectric layers 14 were excessively extended in the pressing step and were fired in this state and thus suffered cracking, crazing, or the like.

Subsequently, each of the 72 multilayer ceramic capacitors according to each of the examples used in (2) was mounted on a substrate and was subjected to a moisture resistance test. The moisture resistance test was executed by applying a voltage of 25 V to the substrates each provided with the mounted multilayer ceramic capacitor for 200 hours at a humidity of 95% and a temperature of 120° C.

An outer appearance of each of the multilayer ceramic capacitors mounted on the substrates was observed by optical microscopy. Multilayer ceramic capacitors having metal precipitated on the surface of the multilayer body 2 provided with neither the first outer electrode 3A nor the second outer electrode 3B were counted as migration defective products, and the migration fraction defective was calculated with the total number of the multilayer ceramic capacitors used for the verification as a denominator. FIG. 4 indicates results thereof in “migration fraction defective”.

Comparative Example 1 had a high migration fraction defective of 32/72. Example 1 had a migration fraction defective of 9/72. Examples 2, 3, 4, 5, 6, and 7 each had a migration fraction defective of 0/72.

FIG. 4 indicates evaluation results based on the results of verification mentioned above. In FIG. 4, a double circle (⊚) indicates a case where the migration fraction defective is 0/72 and the structural defect fraction defective is 0/72, a single circle (○) indicates a case where one of the migration fraction defective and the structural defect fraction defective is 0/72 and the other one thereof is 10/72 or less, and a cross (×) indicates a case where one of the migration fraction defective and the structural defect fraction defective exceeds 10/72.

As indicated in FIG. 4, a migration defect is likely to occur if T2/T1 is less than 1.0 as in Comparative Example 1. However, T2/T1 being about 1.010 or more in a preferred range according to the present example embodiment was found to exhibit an excellent effect of reducing the likelihood of a migration defect. Furthermore, T2/T1 being about 1.033 or more and about 1.201 or less in a more preferred range according to the present example embodiment was found to exhibit an excellent effect of reducing the likelihood of a structural defect.

The multilayer ceramic capacitors 1 according to example embodiments have been described above. The present invention is not limited to the above, and the following various variations are also included in the scope of the present invention.

As shown in FIG. 2, according to the present example embodiment, the dimension in the stacking direction T between the first principal surface A1 and the second principal surface A2 is constant from the position at about ½ of the dimension in the width direction W to both end portions (the first side surface B1 and the second side surface B2) in the width direction W in the WT section in the center portion in the length direction L.

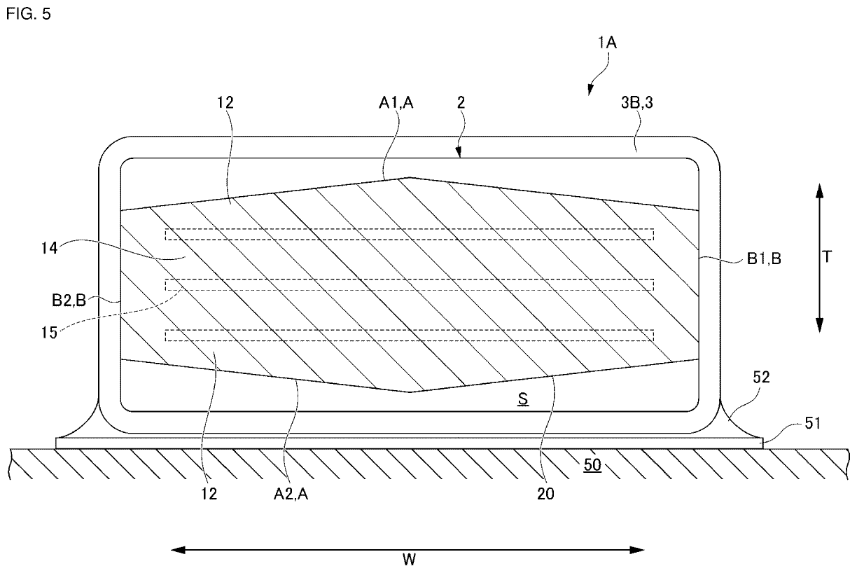

The configuration is, however, not limited to the example embodiments described above. FIG. 5 is a view of a multilayer ceramic capacitor 1A according to the first variation of an example embodiment of the present invention. As shown in FIG. 5, the dimension in the stacking direction T between the first principal surface A1 and the second principal surface A2 may be gradually decreased from the center portion in the width direction W to both end portions (the first side surface B1 and the second side surface B2) in the width direction W. In this case, both the first principal surface A1 and the second principal surface A2 may be shaped to protrude in the center portion in the width direction W.

The multilayer ceramic capacitor 1A according to the first variation can also exhibit an effect similar to that of the example embodiment. Furthermore, the multilayer ceramic capacitor 1A according to the first variation includes a larger inlet and a larger outlet for the flux cleansing liquid to and from the space S in comparison to the multilayer ceramic capacitor 1 shown in FIG. 2. The flux cleansing liquid can thus flow into and can flow out of the space S more easily to further improve detersiveness.

Moreover, the first principal surface A1 and the second principal surface A2 are shaped identically in the first variation. Any one of the first principal surface and the second principal surface A2 can therefore be selected as a mount surface.

As shown in FIG. 3, in the LT section according to the present example embodiment, the recessed portion 20 formed in the second principal surface A2 has a contour in an arc or elliptical arc shape.

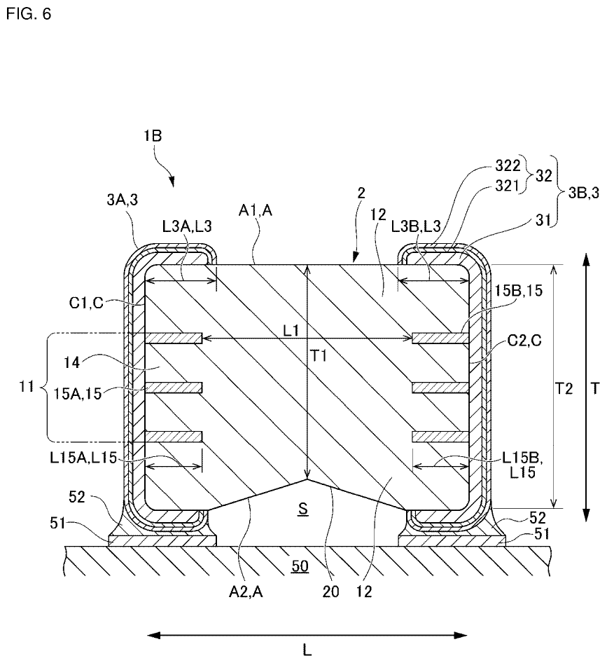

The configuration is, however, not limited to the example embodiment. FIG. 6 is a view of a multilayer ceramic capacitor 1B according to the second variation of an example embodiment of the present invention. As shown in FIG. 6, the recessed portion 20 formed in the second principal surface A2 may have a contour formed by two sides of a triangle including a vertex positioned at the center in the width direction W, that is, two straight lines. The multilayer ceramic capacitor 1B according to the second variation can also exhibit an effect similar to that of the example embodiments described above.

As shown in FIG. 3, according to the present example embodiment, the first principal surface A1 is flat, and the second principal surface A2 as a substrate mounting surface is recessed in the stacking direction T to form the recessed portion 20. The configuration is, however, not limited thereto.

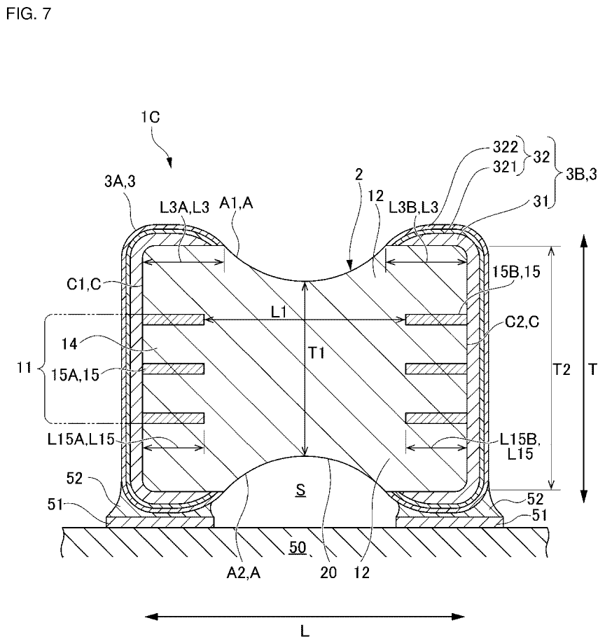

FIG. 7 is a view of a multilayer ceramic capacitor 1C according to the third variation. In the multilayer ceramic capacitor 1C according to the third variation, both the first principal surface A1 and the second principal surface A2 as a substrate mounting surface may be recessed in the stacking direction T. The multilayer ceramic capacitor 1C according to the third variation can also exhibit an effect similar to that of the example embodiments described above.

As shown in FIG. 3, according to the present example embodiment, the first principal surface A1 is flat, and the second principal surface A2 as a substrate mounting surface is recessed in the stacking direction T to form the recessed portion 20 that has a contour in a smooth arc or elliptical arc shape. The configuration is, however, not limited thereto.

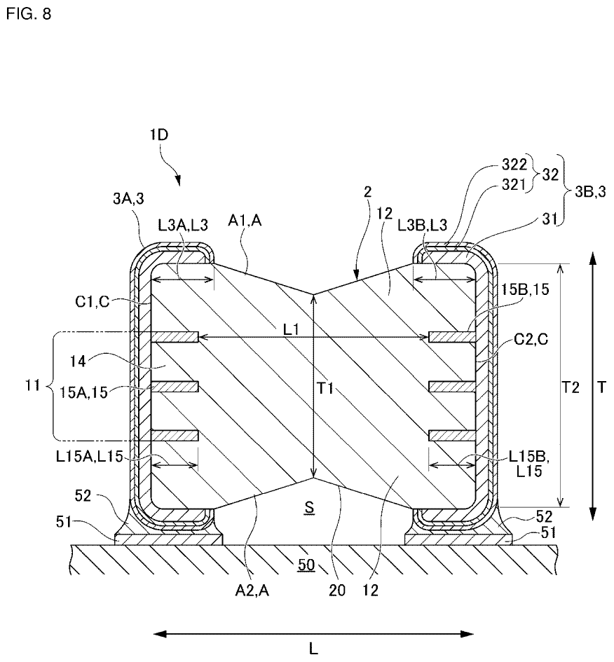

FIG. 8 is a view of a multilayer ceramic capacitor 1D according to the fourth variation. In the multilayer ceramic capacitor 1D according to the fourth variation, both the first principal surface A1 and the second principal surface A2 as a substrate mounting surface may be recessed in the stacking direction T. Furthermore, the recessed portions 20 according to the fourth variation may have a contour formed by two sides of a triangle including a vertex positioned at the center in the width direction W, that is, two straight lines, in a section shown in FIG. 8. The multilayer ceramic capacitor 1D according to the fourth variation can also exhibit an effect similar to that of the example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
a plurality of dielectric layers and a plurality of inner electrodes stacked alternately;
a first principal surface and a second principal surface facing each other in a stacking direction;
a first side surface and a second side surface facing each other in a width direction perpendicular to the stacking direction; and
a first end surface and a second end surface facing each other in a length direction perpendicular to the stacking direction and the width direction;
the plurality of inner electrodes including a first inner electrode extended to the first end surface and a second inner electrode extended to the second end surface;
a first outer electrode on the first end surface; and
a second outer electrode on the second end surface; wherein in the multilayer body, in a section along the length direction and the stacking direction in a center portion in the width direction, a dimension in the stacking direction between the first principal surface and the second principal surface in a center portion in the length direction is smaller than a dimension in the stacking direction between the first principal surface and the second principal surface in both end portions in the length direction.

2. The multilayer ceramic capacitor according to claim 1, wherein the multilayer body has a dimension in the length direction smaller than a dimension thereof in the width direction.

3. The multilayer ceramic capacitor according to claim 1, wherein in the multilayer body, in the first side surface and the second side surface, a dimension in the stacking direction between the first principal surface and the second principal surface in the center portion in the length direction is smaller than a dimension in the stacking direction between the first principal surface and the second principal surface in both end portions in the length direction.

4. The multilayer ceramic capacitor according to claim 1, wherein in the multilayer body, in the section along the length direction and the stacking direction in the center portion in the width direction, a dimension between the first principal surface and the second principal surface increases at least partially from the center portion in the length direction to both end portions in the length direction.

5. The multilayer ceramic capacitor according to claim 1, wherein the first inner electrode and the second inner electrode do not overlap each other in the stacking direction.

6. The multilayer ceramic capacitor according to claim 1, wherein a total of dimensions in the length direction of the first inner electrode and the second inner electrode is smaller than a dimension in the length direction of the multilayer body.

7. The multilayer ceramic capacitor according to claim 1, wherein
the first outer electrode extends from the first end surface to a portion of the first principal surface and a portion of the second principal surface;
the second outer electrode extends from the second end surface to a portion of the first principal surface and a portion of the second principal surface;
the first inner electrode has a dimension in the length direction smaller than an average dimension in the length direction of the first outer electrode on the first principal surface and the second principal surface; and
the second inner electrode has a dimension in the length direction smaller than an average dimension in the length direction of the second outer electrode on the first principal surface and the second principal surface.

8. The multilayer ceramic capacitor according to claim 1, wherein the first inner electrode and the second inner electrode are located in an identical plane along the width direction and the length direction.

9. The multilayer ceramic capacitor according to claim 1, wherein each of the dielectric layers includes at least one of Ca, Sr, Zr, or Ti.

10. The multilayer ceramic capacitor according to claim 1, wherein the first inner electrode, the second inner electrode, the first outer electrode, and the second outer electrode each include at least one of Ni, Cu, Ag, Pd, an alloy of Ag and Pd, or Au.

11. The multilayer ceramic capacitor according to claim 1, wherein the first inner electrode and the second inner electrode each include Cu.

12. The multilayer ceramic capacitor according to claim 1, wherein the first outer electrode and the second outer electrode each include Cu and glass.

13. The multilayer ceramic capacitor according to claim 1, wherein the first inner electrode and the second inner electrode each include Ni.

14. The multilayer ceramic capacitor according to claim 1, wherein the first outer electrode and the second outer electrode each include Ni and a ceramic component.

15. The multilayer ceramic capacitor according to claim 1, wherein T2/T1 is about 1.033 or more and about 1.201 or less.

16. The multilayer ceramic capacitor according to claim 1, wherein the first principal surface and the second principal surface are shaped identically.

17. The multilayer ceramic capacitor according to claim 1, wherein the second principal surface includes a recessed portion with an arc or elliptical arc shaped contour.

18. The multilayer ceramic capacitor according to claim 1, wherein the first principal surface is flat and the second principal surface is recessed in the stacking direction.

19. The multilayer ceramic capacitor according to claim 1, wherein each of the first principal surface and the second principal surface are recessed in the stacking direction.
